(19) United States
(12) Patent Application Publication
(10) Pub. No.: US 2026/0152033 A1
(43) Pub. Date: Jun. 4, 2026

(54) VEHICLE HEIGHT CONTROL METHOD

(71) Applicant: HYUNDAI MOBIS CO., LTD., Seoul (KR)

(72) Inventor: Young Il KIM, Yongin-si (KR)

(73) Assignee: HYUNDAI MOBIS CO., LTD., Seoul (KR)

(21) Appl. No.: 19/313,006

(22) Filed: Aug. 28, 2025

(30) Foreign Application Priority Data
Dec. 2, 2024 (KR) 10-2024-0176601

(51) Int. Cl. B60G 17/0165; B60G 17/015

(52) U.S. Cl. CPC B60G 17/0165; B60G 17/0155; B60G 2202/152; B60G 2400/821; B60G 2500/32

(57) ABSTRACT

A method of controlling a vehicle height includes: determining whether the vehicle is traveling on a rough road; determining that vehicle height adjustment is necessary when, during rough road travel, a state in which a long-period vehicle height deviation at each corner exceeds a predetermined reference range continues for at least a predetermined reference time; and performing vehicle height adjustment at each corner according to a predetermined control sequence when vehicle height adjustment is determined to be necessary.

### CROSS-REFERENCE TO RELATED APPLICATION(S)

This application is based on and claims priority under 35 U.S.C. 119 to Korean Patent Application No. 10-2024-0176601, filed on Dec. 2, 2024, in the Korean Intellectual Property Office, the disclosure of which is herein incorporated by reference in its entirety.

### BACKGROUND OF THE INVENTION

### 1. Field of the invention

The present disclosure relates to a technology for controlling vehicle height.

### 2. Description of the Prior Art

A conventional vehicle equipped with an air suspension system employs a feedback control method in which a difference between a target vehicle height and a current vehicle height is calculated based on a signal from a vehicle height sensor, and the vehicle height is controlled to converge to the target vehicle height using the calculated difference.

When a vehicle travels on a rough road, large vehicle motions continuously occur, causing rapid changes in the signal from the vehicle height sensor. In this case, the difference between the target vehicle height and the current vehicle height also rapidly changes, which reduces the stability of the feedback control. Therefore, it is common to temporarily suspend the vehicle height control itself.

Meanwhile, when the vehicle travels on a rough road, it is advantageous to maintain a higher vehicle height than the normal vehicle height in order to protect the vehicle underbody. However, when the vehicle height control is suspended and the vehicle continues to travel on a rough road for a long period of time, a phenomenon in which the vehicle body sags, resulting in a lowered vehicle height, may occur for various reasons. In such a case, damage to the vehicle underbody or the air suspension system may occur.

The foregoing described as the background art is intended merely to aid in the understanding of the background of the present disclosure, and is not intended to mean that the present disclosure falls within the purview of the related art already known to those skilled in the art.

### SUMMARY OF THE INVENTION

The present disclosure provides a vehicle height control method that performs appropriate vehicle height adjustment when a vehicle travels on a rough road for a long period of time, thereby preventing damage to components such as the vehicle underbody or the air suspension system, and also continuously maintaining a stable vehicle height as much as possible so as to ensure excellent ride comfort during driving.

The technical subjects pursued in the present disclosure may not be limited to the above-mentioned technical subjects, and other technical subjects which are not mentioned herein may be clearly understood from the following description by those skilled in the art to which the present disclosure pertains.

In view of the foregoing, a method of controlling a vehicle height according to the present disclosure includes steps of: determining whether the vehicle is traveling on a rough road; determining that vehicle height adjustment is necessary when, during rough road travel, a state in which a long-period vehicle height deviation at each corner exceeds a predetermined reference range continues for at least a predetermined reference time; and performing vehicle height adjustment at each corner according to a predetermined control sequence when vehicle height adjustment is determined to be necessary.

When a state in which an amount of vehicle height change per unit time is equal to or greater than a predetermined reference amount of change continues for at least a predetermined judgment time, it may be determined that the vehicle is traveling on a rough road.

The long-period vehicle height deviation may include a multi-moving average deviation of a vehicle height at each corner with respect to a target vehicle height.

When a state in which at least one of the long-period vehicle height deviations at respective corners exceeds the predetermined reference range continues for at least the predetermined reference time, it may be determined that the vehicle height adjustment is necessary.

The vehicle height adjustment may be sequentially performed starting from a corner having the largest long-period vehicle height deviation among the long-period vehicle height deviations at the respective corners.

The vehicle height adjustment may be performed while distinguishing between upward adjustment and downward adjustment of the vehicle height.

In the upward adjustment of the vehicle height, the vehicle height adjustment may be performed by setting a longer adjustment time than in the downward adjustment of the vehicle height.

The vehicle height adjustment time may be set in proportion to the long-period vehicle height deviation when adjusting the vehicle height.

When adjusting the vehicle height in the case where the vehicle is equipped with an air suspension system, an air spring of a control target corner may be adjusted for the vehicle height adjustment time.

When execution of the vehicle height adjustment is completed or when it is determined that the vehicle is no longer traveling on the rough road, the vehicle height adjustment may be terminated.

According to the present disclosure, appropriate vehicle height adjustment is performed when a vehicle travels on a rough road for a long period of time, thereby preventing damage to components such as the vehicle underbody or the air suspension system, and also continuously maintaining a stable vehicle height as much as possible so as to ensure excellent ride comfort.

Advantageous effects obtainable from the present disclosure may not be limited to the above-mentioned effects, and other effects which are not mentioned herein may be clearly understood from the following description by those skilled in the art to which the present disclosure pertains.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a conceptual view of a vehicle equipped with an air suspension system to which the vehicle height control method according to the present disclosure is applicable;

FIG. 2 is a flowchart illustrating an embodiment of the vehicle height control method according to the present disclosure;

FIG. 3 is a conceptual graph illustrating a process in which vehicle height control according to the present disclosure is initiated based on a vehicle height sensor signal of a specific corner; and

FIG. 4 is a graph illustrating that a compressor and air springs of respective corners are sequentially operated over time during vehicle height control.

### DETAILED DESCRIPTION OF THE EXEMPLARY EMBODIMENTS

In describing the embodiments set forth herein, a detailed description of known functions or configurations incorporated herein will be omitted when it is determined that the description may make the subject matter of the embodiments set forth herein unclear. In addition, it should be appreciated that the accompanying drawings are provided only for the sake of easy understanding of the embodiments set forth herein, and the technical idea of the present disclosure is not limited to the accompanying drawings and includes all modifications, equivalents, or alternatives falling within the spirit and scope of the present disclosure.

Terms including an ordinal number such as “a first” and “a second” may be used to describe various elements, but the elements are not limited to the terms. The above terms are used merely for the purpose of distinguishing one element from other elements.

A singular expression may include a plural expression unless they are definitely different in a context.

As used herein, the expression “include” or “have” is intended to specify the existence of mentioned features, numbers, steps, operations, elements, components, or combinations thereof, and should be construed as not precluding the possible existence or addition of one or more other features, numbers, steps, operations, elements, components, or combinations thereof.

The terms “module” and “unit” used for the elements in the following description are given or interchangeably used in consideration of only the ease of writing the specification, and do not have distinct meanings or roles by themselves.

In the case where an element is referred to as being “connected” or “coupled” to any other elements, it should be understood that not only the element may be directly connected or coupled to the other elements, but also another element may exist therebetween. Contrarily, in the case where an element is referred to as being “directly connected” or “directly coupled” to any other element, it should be understood that no other element exists therebetween.

In addition, a unit or a control unit included in names is merely a term widely used for naming a controller configured to control a specific function of a vehicle, but does not mean a generic function unit.

A controller may include a communication device configured to communicate with a sensor or another control unit, a memory configured to store an operation system, a logic command, or input/output information, and at least one processor configured to perform determination, calculation, decision or the like which are required for responsible function controlling.

Any number of components or a variety of components in any of the configurations described herein may be included in the disclosure described herein. The components may include any combination of the features described herein and may be arranged in any of the various configurations described herein. The concepts relating to the structure and arrangement of the components of the present disclosure, as well as their use and operation, may be applied to any number of embodiments in any combination, as well as to the specific embodiments discussed herein. Embodiments including those having various features in various arrangements are described below with reference to the drawings.

Hereinafter, various embodiments set forth herein will be described in detail with reference to the accompanying drawings, and the same or similar elements are given the same and similar reference numerals regardless of figure numbers, so duplicate descriptions thereof will be omitted.

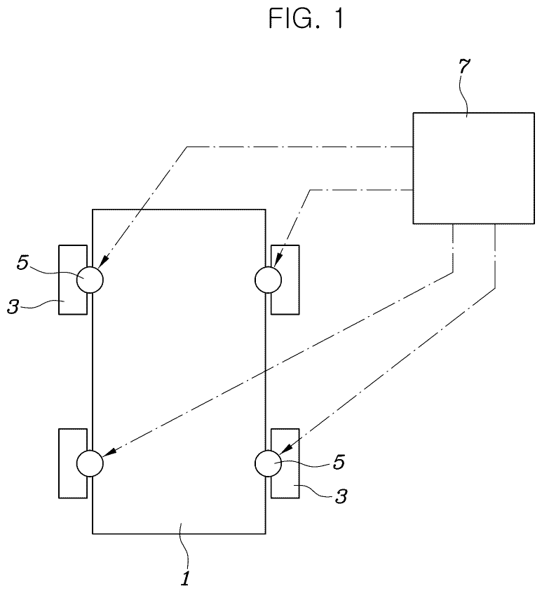

FIG. 1 is a conceptual view of a vehicle equipped with an air suspension system to which the present disclosure is applicable. In the vehicle, wheels 3 at respective corners are supported by air springs 5 with respect to a vehicle body 1, and the air springs 5 are configured to be controlled by a controller 7. According to an exemplary embodiment of the present disclosure, the controller 7 may include a processor (e.g., computer, microprocessor, CPU, ASIC, circuitry, logic circuits, etc.) and an associated non-transitory memory storing software instructions which, when executed by the processor. Herein, the memory and the processor may be implemented as separate semiconductor circuits. Alternatively, the memory and the processor may be implemented as a single integrated semiconductor circuit. The processor may embody one or more processor(s).

Here, the controller 7 may be connected to a plurality of vehicle height sensors capable of sensing the vehicle height at each corner.

Of course, the controller 7 is actually configured to indirectly control each air spring 5 via components such as a compressor and a valve device, but is illustrated here as directly controlling each air spring 5 for the sake of conceptual simplicity.

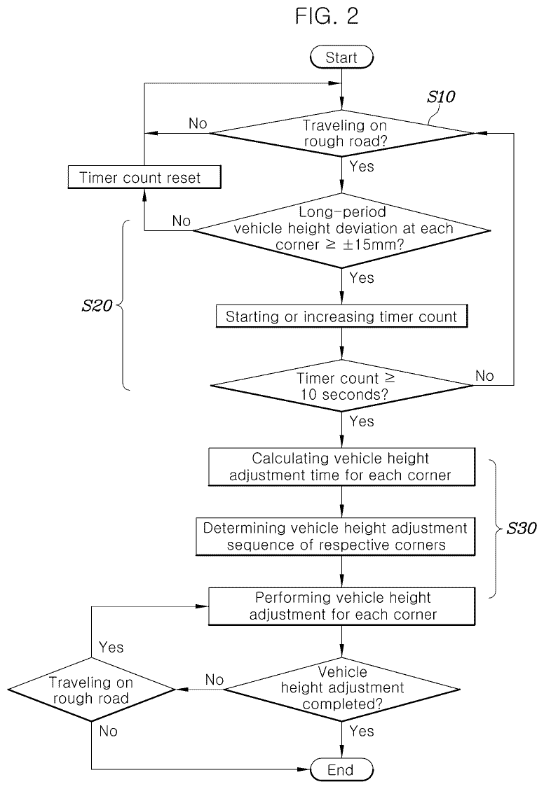

Referring to FIG. 2, an embodiment of the vehicle height control method of the present disclosure includes steps of: determining whether the vehicle is traveling on a rough road (step S10); determining that vehicle height adjustment is necessary when, during rough road travel, a state in which a long-period vehicle height deviation at each corner exceeds a predetermined reference range continues for at least a predetermined reference time (step S20); and performing vehicle height adjustment at each corner according to a predetermined control sequence when vehicle height adjustment is determined to be necessary (step S30).

That is, the present disclosure is directed to determining that vehicle height adjustment is necessary when, during travel on a rough road, a state in which a long-period vehicle height deviation exceeds a predetermined reference range continues for at least a predetermined reference time, and performing the vehicle height adjustment so as to prevent damage to components such as the vehicle underbody or the air suspension system.

Here, the vehicle height adjustment may be implemented by controlling the air spring 5 of a control target corner for a vehicle height adjustment time that is set in proportion to the long-period vehicle height deviation relative to a target vehicle height at each corner, as will be described later. Since the vehicle height adjustment has the nature of a type of feedforward control, stable vehicle height control may be achieved without being affected by rapid changes in vehicle height on a rough road, thereby ensuring relatively excellent ride comfort.

For reference, the term “corner” refers to a portion of the vehicle where each wheel 3 is disposed, as illustrated in FIG. 1, and may be interpreted as a portion of the vehicle body 1 where a suspension system, such as an air spring 5, capable of vehicle height adjustment, and the wheel 3 are disposed.

In addition, the target vehicle height may be set by the controller 7 according to the vehicle speed, or may also be set based on the driver's selection.

In this embodiment, it is determined that the vehicle is traveling on a rough road when a state in which the amount of vehicle height change per unit time is equal to or greater than a predetermined reference amount of change continues for at least a predetermined judgment time.

For example, the controller 7 may determine that the vehicle is traveling on a rough road when a state in which the amount of vehicle height change per second is 13 mm or more continues for 3 seconds or more.

Here, the amount of vehicle height change refers to the amount of vehicle height change at each corner, and when the above-mentioned condition is satisfied by the amount of vehicle height change at any one corner, it may be determined that the vehicle is traveling on a rough road. Alternatively, it may also be possible to configure the controller 7 to determine whether the vehicle is traveling on a rough road by determining whether the amount of vehicle height change at two or more corners, or at all corners, satisfies the above-mentioned condition.

In addition, the unit time may be set to about 1 second, 2 seconds, or 3 seconds, as described above, and the reference amount of change may be set, through experimentation and analysis, to a level at which it is possible to identify that the vehicle is traveling on a rough road, the level ranging from several millimeters to several tens of millimeters. The judgment time may also be determined by design, through experimentation and analysis, to a level at which a rough road can be reliably identified, as distinguished from, for example, simply passing over irregularities.

In addition, the unit time, the reference amount of change, and the judgment time may be set to be variable depending on the vehicle speed.

Meanwhile, the long-period vehicle height deviation includes a multi-moving average deviation of the vehicle height at each corner with respect to a target vehicle height.

For example, for each corner, a first signal may be obtained by taking ten samples, at 1-second intervals, of the difference between the target vehicle height and a signal from a vehicle height sensor and calculating the average of the samples. Then, a second signal may be obtained by taking twelve samples, at 2-second intervals, of the first signal and calculating the average of the samples, and this second signal may be used as the long-period vehicle height deviation.

This has an effect similar to passing the vehicle height sensor signal through a low-pass filter, thereby making it possible to identify a more reliable trend of the vehicle height during travel on a rough road, and to more accurately identify whether the vehicle body 1 is excessively sagging or rising.

Of course, in the process of calculating the long-period vehicle height deviation, a separate low-pass filter may be used, for example, by processing the signal from the vehicle height sensor with a low-pass filter, and thereafter, the above-described multi-moving average may be calculated again.

In this embodiment, it is determined that the vehicle height adjustment is necessary when a state in which at least one of the long-period vehicle height deviations at the respective corners exceeds the predetermined reference range continues for at least the predetermined reference time.

Here, the reference range may be determined by design through experimentation and analysis, considering, for example, a vehicle height that may become excessively low, possibly causing damage to components such as the vehicle underbody or the air suspension system, or a vehicle height that becomes excessively high, possibly leading to a significant decrease in driving stability during rough road travel. As illustrated in FIG. 2, the reference range may be set to ±15 mm from the target vehicle height.

In addition, the judgment time may be set to, for example, 10 seconds as illustrated in FIG. 2, and may be set to a level capable of reliably determining a condition requiring vehicle height control, excluding cases of temporary lowering or rising of the vehicle height.

Meanwhile, the vehicle height adjustment is sequentially performed starting from the corner having the largest long-period vehicle height deviation among the long-period vehicle height deviations of the respective corners.

For example, when the long-period vehicle height deviation at the right-rear corner is the largest, the vehicle height of the right-rear corner is adjusted first to reach the target vehicle height, and then the vehicle heights of the other corners are sequentially adjusted in order of decreasing deviation.

Accordingly, for example, if the long-period vehicle height deviation at the right-rear corner is the largest, it may be considered that the right-rear portion of the vehicle underbody is most likely to be damaged by the road surface. Therefore, by adjusting the vehicle height by raising the vehicle body starting from this corner, the vehicle body may be safely protected from damage.

The vehicle height adjustment may be performed while distinguishing between upward adjustment and downward adjustment of the vehicle height.

For example, in the case of upward adjustment, the vehicle height adjustment may be performed by setting a longer adjustment time than in the case of downward adjustment.

That is, the vehicle height adjustment time is set such that the vehicle height adjustment time equals 1×long-period vehicle height deviation in the case of upward adjustment of the vehicle height and vehicle height adjustment time equals 0.2×long-period vehicle height deviation in the case of downward adjustment of the vehicle height, and in a vehicle equipped with an air suspension system, the vehicle height adjustment is performed by controlling the air spring 5 of the control target corner during the vehicle height adjustment time.

This is because it takes longer to raise the vehicle height by the same displacement than to lower the vehicle height, considering the control characteristics of the air spring 5.

Accordingly, the coefficient multiplied by the long-period vehicle height deviation to calculate the vehicle height adjustment time should be appropriately set considering, for example, the type of vehicle and the characteristics of the air suspension.

In addition, from the equation for calculating the vehicle height adjustment time, it may be understood that the vehicle height adjustment time is set in proportion to the long-period vehicle height deviation.

The vehicle height adjustment as described above is terminated when the execution of the vehicle height adjustment is completed or when it is determined that the vehicle is no longer traveling on a rough road.

That is, the present disclosure continuously and repeatedly performs the series of processes illustrated in FIG. 2 during vehicle travel, and once the vehicle height adjustment is completed after being initiated, the vehicle height adjustment is terminated, and then the series of processes of FIG. 2 is performed again from the beginning.

Of course, when it is determined, during the vehicle height adjustment, that the vehicle is no longer traveling on a rough road, the vehicle height adjustment according to the present disclosure is immediately stopped, and normal feedback control corresponding to ordinary road travel conditions is performed.

For reference, in FIG. 2, it is reasonable to understand that “starting or increasing timer count” means that if the timer is in a reset initial value state, the timer count is started, and if the timer count is a value exceeding the initial value, the timer is continuously increased.

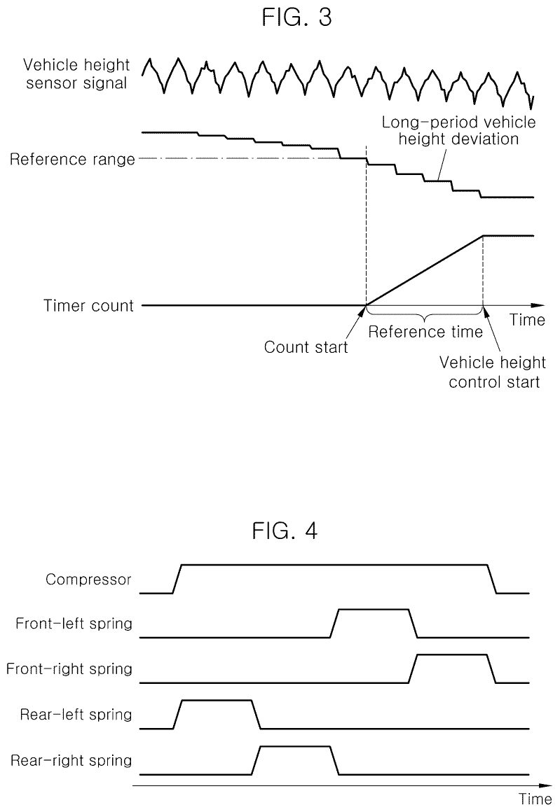

For reference, FIG. 3 is a conceptual graph illustrating, over time, a process in which vehicle height control is initiated as the timer count increases and the condition continues until the reference time elapses based on the vehicle height sensor signal and the long-period vehicle height deviation of a specific corner. FIG. 4 illustrates an example of vehicle height control, illustrating that the compressor and the air springs 5 of the respective corners are sequentially operated over time.

Although the present disclosure has been described and illustrated in conjunction with particular embodiments thereof, it will be apparent to those skilled in the art that various improvements and modifications may be made to the present disclosure without departing from the technical idea of the present disclosure defined by the appended claims.

What is claimed is:

1. A method for controlling a vehicle height, the method comprising:
determining whether the vehicle is traveling on a rough road;
determining that vehicle height adjustment is necessary when, during rough road travel, a state in which a long-period vehicle height deviation at each corner exceeds a predetermined reference range continues for at least a predetermined reference time; and
in response to a determination that vehicle height adjustment is necessary, performing vehicle height adjustment at each corner according to a predetermined control sequence.

2. The method of claim 1, wherein, when a state in which an amount of vehicle height change per unit time is equal to or greater than a predetermined reference amount of change continues for at least a predetermined judgment time, it is determined that the vehicle is traveling on a rough road.

3. The method of claim 1, wherein the long-period vehicle height deviation comprises a multi-moving average deviation of a vehicle height at each corner with respect to a target vehicle height.

4. The method of claim 1, wherein, when a state in which at least one of the long-period vehicle height deviations at respective corners exceeds the predetermined reference range continues for at least the predetermined reference time, it is determined that the vehicle height adjustment is necessary.

5. The method of claim 1, wherein the vehicle height adjustment is sequentially performed starting from a corner having a long-period vehicle height deviation that is the largest among the long-period vehicle height deviations at the respective corners.

6. The method of claim 1, wherein the vehicle height adjustment is performed while distinguishing between upward adjustment and downward adjustment of the vehicle height.

7. The method of claim 6, wherein, in the upward adjustment of the vehicle height, the vehicle height adjustment is performed by setting a longer adjustment time than in the downward adjustment of the vehicle height.

8. The method of claim 7, wherein the vehicle height adjustment time is set in proportion to the long-period vehicle height deviation when adjusting the vehicle height.

9. The method of claim 8, wherein, when adjusting the vehicle height in a case where the vehicle is equipped with an air suspension system, an air spring of a control target corner is adjusted for the vehicle height adjustment time.

10. The method of claim 1, wherein the vehicle height adjustment is terminated when execution of the vehicle height adjustment is completed or when it is determined that the vehicle is no longer traveling on the rough road.
